(19) United States
(12) Patent Application Publication
(10) Pub. No.: US 2015/0132049 A1
(43) Pub. Date: May 14, 2015

(54) SPRING LOADED RETAINER DEVICE FOR SECURING SUCTION WANDS

(71) Applicant: Don M. Buckner, Okahumpka, FL (US)

(72) Inventor: Don M. Buckner, Okahumpka, FL (US)

(21) Appl. No.: 14/075,434

(22) Filed: Nov. 8, 2013

(51) Int. Cl. F16B 21/06

(52) U.S. Cl. CPC F16B 21/06
USPC 403/322.1

(57) ABSTRACT

A spring loaded retainer device for securing suction wands is disclosed. The device includes a handle configured to be gripped by an operator, a hollow cylinder, and a plunger disposed within the hollow cylinder, where a proximate end of the plunger is secured to the handle used to pull the plunger outward of the hollow cylinder. In addition, the device includes a spring that surrounds the plunger and biases a distal end of the plunger inward of the hollow cylinder and when the handle is released the spring pushes the plunger inward of the hollow cylinder. Opposing lateral tips of the handle are each configured to restrain an end of a suction wand being stored inside a compartment when the handle is rotated in line with a substantially horizontal axis, where the handle is configured to be pulled outwards and rotated in line with a substantially vertical axis when removing the suction wand from the compartment.

### I. FIELD OF THE INVENTION

The present invention relates generally to a spring loaded retainer device for securing suction wands.

### II. BACKGROUND

Industrial vacuum equipment has dozens of wet and dry uses such as hydro excavation, air excavation and vacuum excavation. In addition, the equipment can be used for directional drilling slurry removal, industrial clean-up, waste clean-up, lateral and storm drain clean-out, oil spill clean-up and other natural disaster clean-up applications. The vacuum systems may be mounted to a truck or trailer and are typically powered by gas or diesel engines.

The vacuum systems include a debris tank that is used to collect the material using a large three or four inch diameter hose. The hoses are typically long and flexible with spiral wound corrugations along the length of the hose. Accordingly, the hoses are generally heavy and cumbersome to handle. The hoses are conventionally stored on the rear of the debris tank using hooks to coil the hoses and secure to the tank. However, often times a rigid hose extension also know as a suction wand is connected to the end of the flexible vacuum hoses, which the suction wand is adapted to be held by an operator so that the end of the suction wand can be forced into the ground when vacuuming up debris. The suction wand is not adapted to be coiled and stored on the debris tank. Accordingly, there is a need in the art for a storage system for storing suction wands that is easy to use to safely and securely store the suction wands.

### III. SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In a particular embodiment, a spring loaded retainer device for securing suction wands is disclosed. The device includes a handle configured to be gripped by an operator, a hollow cylinder, and a plunger disposed within the hollow cylinder, where a proximate end of the plunger is secured to the handle used to pull the plunger outward of the hollow cylinder. In addition, the device includes a spring that surrounds the plunger and biases a distal end of the plunger inward of the hollow cylinder and when the handle is released the spring pushes the plunger inward of the hollow cylinder. Opposing lateral tips of the handle are each configured to restrain an end of a suction wand being stored inside a compartment when the handle is rotated in line with a substantially horizontal axis, where the handle is configured to be pulled outwards and rotated in line with a substantially vertical axis when removing the suction wand from the compartment.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### IV. BRIEF DESCRIPTION OF THE DRAWINGS

FIG. 1 is a side elevational view of a spring loaded retainer device mounted on a truck;

FIG. 2 is a top view of the spring loaded retainer device shown in FIG. 1 taken in the direction of lines 2-2 and loaded with suction wands;

FIG. 3 is a front elevational view of the spring loaded retainer device shown in FIG. 2 taken in the direction of lines 3-3;

FIG. 4 is a side elevational view of the spring loaded retainer device;

FIG. 5 is cross sectional view of the spring loaded retainer device shown in FIG. 4 taken in the direction of lines 5-5;

FIG. 6 is side elevational view of the handle of the spring loaded retainer device;

FIG. 7 is a front elevational view of the handle shown in FIG. 6 taken in the direction of lines 7-7;

FIG. 8 is a side elevational view of a plunger of the spring loaded retainer device;

FIG. 9 is a side elevational view of a cylinder of the spring loaded retainer device;

FIG. 10 is a rear elevation view of the cylinder shown in FIG. 9 taken in the direction of lines 10-10; and

FIG. 11 is a side elevational view of a spring of the spring loaded retainer device.

### V. DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

Referring to FIGS. 1-3, a particular illustrative embodiment of a spring loaded retainer device 110 for securing suction wands is disclosed. The vacuum equipment is mounted to a truck 100 or trailer on wheels 104 and includes a debris tank 102 that is configured to be in communication with a pump or blower (not shown). A reel 106 for storing smaller diameter high pressure hoses may also be secured to the truck 100. A storage compartment 108 that is used for the storing suction wands 114 may include tubular cavities that are sized so that suction wands 114 can slide therein. The suction wands 114 that are intended to be used with the storage compartment 108 are most often used with industrial vacuum type equipment. A spring loaded retainer device 110 is positioned adjacent to an end of the storage compartment 108, which prevents the suction wands 114 from unintentionally sliding out of the storage compartment, as described below, when the truck 100 is in transit between locations.

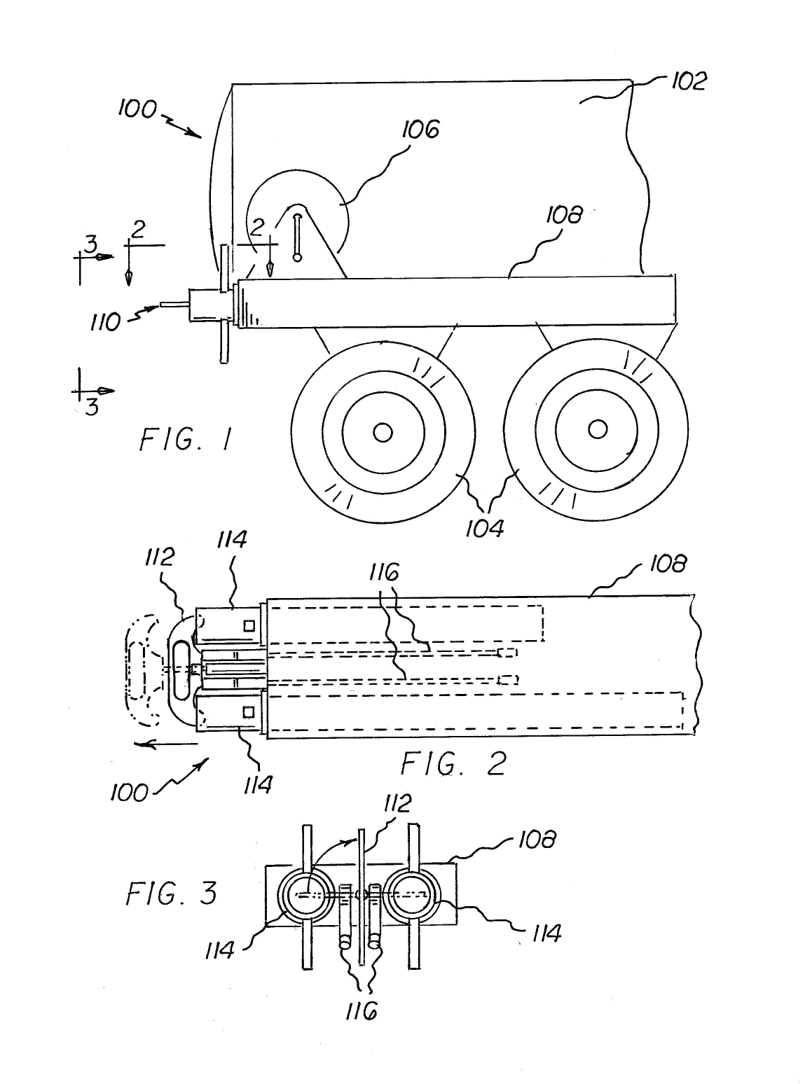

The spring loaded retainer device 110 includes a handle 112 that is generally planar in shape. The handle 112 is configured to contact a respective end of the suction wand 114 to prevent the suction wand 114 from sliding out of an open end of the storage compartment 108 when the handle 112 is in line with a substantially horizontal axis as shown in FIG. 2. An opposing end of the storage compartment is substantially closed or may include a second spring loaded retainer device 110. The handle 112 is configured to be pulled outwards by an operator away from the suction wands 114 and rotated approximately ninety degree in line with a substantially vertical axis as shown in FIG. 3. Once the handle 112 is rotated in line with a substantially vertical axis, then the suction wands 114 can be removed from the storage compartment 108. As the operator releases the handle 112, the handle 112 is biased inwards towards the storage compartment 108 as explained below.

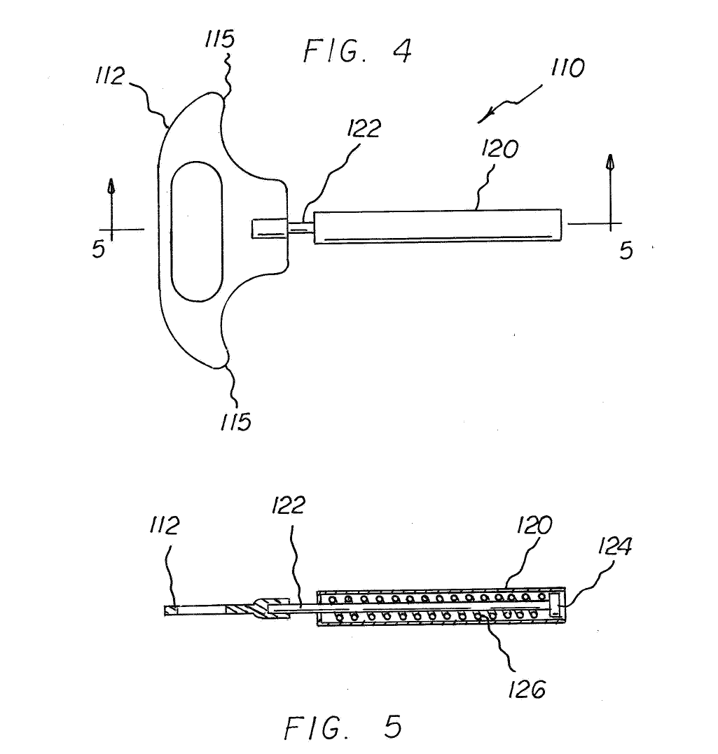

Referring now to FIG. 4, the spring loaded retainer device 110 includes a cylinder 120 that houses a plunger 122 and spring 126. The handle 112 is secured to a proximate end of the plunger 122 and a stopper 124 is secured to a distal end of the plunger 122. As shown in FIG. 5, the spring 126 surrounds the plunger 122 and the spring 126 is contained on one side of the plunger 122 within the cylinder 120. Accordingly, as the handle 112 is pulled outwards away from the cylinder 120, the spring 126 is compressed inside the cylinder 120 by the stopper 124. When the handle 112 is released, the spring 126 pushes the stopper 124 in the opposite direction and inwards of the cylinder 120 causing the handle to move inwards towards the cylinder 120. The force of the spring 126 is greater than the forces acting on the suction wands 114 sliding out of the storage compartment 108 so that the suction wands 114 are secure within the storage compartment 108.

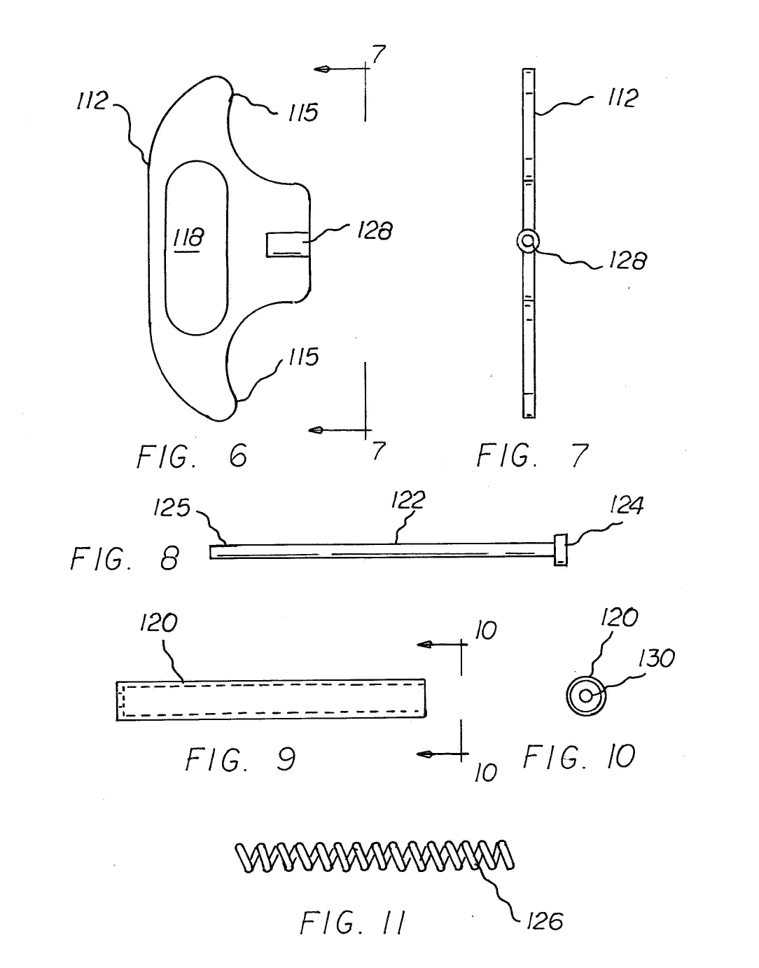

Referring now to FIGS. 6 and 7 showing the individual components of the spring loaded retainer device 110, the handle 112 of the spring loaded retainer device 110 includes an aperture 118 for the operator to place a hand to grip the handle 112. The aperture 118 makes it easier for the operator to pull the handle 112 outwards and to apply the torque necessary to rotate the handle 112 between the horizontal axis and the vertical axis. The handle 112 may be T-shaped with opposing lateral ends 115 of the handle 112 configured to abut an end of the respective suction wand 114 and prevent the suction wand 114 from sliding out of the storage compartment 108.

As described above, the storage compartment 108 may include hollow tubes for the suction wands 114 to slide into and once the lateral ends 115 of the handle 112 are rotated out of the way, the operator can pull the suction wands 114 out from the storage compartment 108. As shown in FIG. 7, the handle 112 is generally planar in shape and may include a receptacle 128 for receiving a proximate end 125 of a plunger 122. Alternatively, the handle 112 and plunger 122 may be formed as a single piece.

The plunger 122 may be rod-shaped with the stopper 124 secured to the distal end of the plunger 122 as shown in FIG. 8. The plunger 122 is configured to ride within the cylinder 120 and to compress the spring 126 when the handle 112 is pulled outward. Referring now to FIG. 9, the cylinder 120 is hollow and is configured to allow the stopper 124 to move within the cylinder 120. An opening 130 is disposed in one end of the cylinder 120 and is sized to serve as a guide for the plunger 122 as the plunger 122 moves within the cylinder 120. The spring 126 is shown in FIG. 11 that is used to provide the resistance to the movement of the handle 112, however, alternative means of resistance may be used such as pneumatic or friction resistance, for example.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A spring loaded retainer device for securing suction wands, the device comprising:
a handle configured to be gripped by an operator;
a hollow cylinder;
a plunger disposed within the hollow cylinder, wherein a proximate end of the plunger is secured to the handle used to pull the plunger outward of the hollow cylinder;
a spring that surrounds the plunger and biases a distal end of the plunger inward of the hollow cylinder and when the handle is released the spring pushes the plunger inward of the hollow cylinder; and
opposing lateral tips of the handle are each configured to restrain an end of a suction wand being stored inside a compartment when the handle is rotated in line with a substantially horizontal axis, wherein the handle is configured to be pulled outwards and rotated in line with a substantially vertical axis when removing the suction wand from the compartment.

2. The device of claim 1, wherein the compartment includes a tubular cavity to slide the suction wand therein.

3. The device of claim 2, wherein the handle further comprises an aperture for an operator's hand.

4. The device of claim 3, wherein the compartment is secured to a vacuum truck.

5. The device of claim 4, wherein the handle is planar shaped.

6. The device of claim 5, wherein the suction wand is configured for use with a vacuum hose.

7. The device of claim 6, wherein the distal end of the plunger further comprises a stopper configured to compress the spring when the handle is pulled outwards and to prevent the plunger from being removed completely from the cylinder.

8. The device of claim 7, wherein the handle further comprising a shoulder to abut against the cylinder.

9. A spring loaded retainer device for securing suction wands, the device comprising:
a rotatable handle configured to be gripped by an operator;
a hollow cylinder;
a plunger disposed within the hollow cylinder, wherein a proximate end of the plunger is secured to the handle used to pull the plunger outward of the hollow cylinder;
a spring that surrounds the plunger and biases a distal end of the plunger inward of the hollow cylinder and when the handle is released the spring pushes the plunger inward of the hollow cylinder;
a tubular cavity disposed within a storage compartment to slide and store a suction wand therein; and
opposing lateral tips of the handle are each configured to restrain an end of the suction wand being stored inside the compartment.

10. The device of claim 9, wherein the handle is T-shaped.

11. A spring loaded retainer device for securing suction wands, the device comprising:
a handle configured to be gripped by an operator;
a spring loaded plunger disposed within a hollow cylinder, wherein when the handle is released the plunger is pulled inward of the hollow cylinder; and
opposing lateral tips of the handle are each configured to restrain a suction wand within a compartment.

12. The device of claim 11, wherein the handle is configured to rotate between a substantially vertical axis and a substantially horizontal axis.
